(19) United States
(12) Patent Application Publication
(10) Pub. No.: US 2003/0061703 A1
(43) Pub. Date: Apr. 3, 2003

(54) Method of manufacturing a motor casing

(75) Inventors: Atsushi Nagai, Nagano (JP); Ikuo Agematsu, Nagano (JP)

Correspondence Address: SUGHRUE MION, PLLC, 2100 PENNSYLVANIA AVENUE, N.W., WASHINGTON, DC, 20037, US

(73) Assignee: KABUSHIKI KAISHA SANKYO SEIKI SEISAKUSHO

(21) Appl. No.: 10/151,014

(22) Filed: May 21, 2002

(30) Foreign Application Priority Data
May 21, 2001 (JP) P2001-150922

(51) Int. Cl. H02K 15/00; H02K 15/02

(52) U.S. Cl. 29/596; 29/598

(57) ABSTRACT

To provide a method of manufacturing a motor casing with a cut-off portion, which makes it possible to keep the rigidity of the motor casing high, and consequently makes it possible to ensure the dimensional accuracy, and to provide a method of manufacturing a motor casing, which makes it possible to form long pole teeth without being restricted by the radius of a cylindrical portion of the motor casing. In a method of manufacturing a motor casing with a cut-off portion, after a cylindrical side wall portion is formed, each of a pair of cut-off portions is formed by cutting off a portion of the side wall portion.

The present application is based on Japanese Patent Application No. 2001-150922, the entire contents of which are incorporated herein by reference.

### BACKGROUND OF THE INVENTION

The present invention relates to a method of manufacturing a motor casing used for a stepping motor or the like.

In recent years, as sizes of optical apparatuses, information apparatuses, or acoustic apparatus and the like tend to become increasingly smaller, there is a demand for making compact stepping motors and the like which are used in these apparatuses.

In making the motor compact, if the diameter of a rotor is made small, or if the number of windings of coils is reduced, such an attempt leads to the lowering of the motor torque, so that it is not desirable. Accordingly, by keeping the diameter of the rotor or the number of windings of coils as they are, it is possible to realize a compact motor by forming cut-off portions in some portions of a cylindrical motor casing generally in use.

As a manufacturing method of a motor casing with cut-off portions, there is a method in which a plate member having a shape of development for the motor casing is formed at first and then the plate member is bent into a partially cylindrical shape so as to form the side wall portions with the desired shape (a substantially oval shape where a pair of mutually opposing side wall portions of a cylinder are cut off along the axial direction to form two parallel cut-off portions).

At that time, pole teeth are formed by subjecting a bottom portion (which is formed on the side away from the opening side) of a cylindrical or a partially cylindrical motor casing to press working.

However, in the case where the plate member having a shape of development for the motor casing is bent into a partially cylindrical shape so as to form the side wall portions, it is impossible to effect machining in a state in which the rigidity of the motor casing is maintained. Consequently, it is impossible to ensure the dimensional accuracy of the motor casing. Specifically, the side wall portions are formed by bending the plate member by using a jig, and if the jig is removed from the side wall portions, the side wall portions slightly return, so that it is impossible to ensure the dimensional accuracy of the motor casing.

### SUMMARY OF THE INVENTION

The invention has been devised to overcome the above-described problems of the conventional art, and its object is to provide a method of manufacturing a motor casing with a cut-off portion, which makes it possible to effect machining in a state in which the rigidity of the motor casing is kept high, consequently making it possible to ensure the dimensional accuracy.

(1) In the invention, there is provided a method of manufacturing a motor casing with a cut-off portion in a cylindrical side wall portion, characterized by the step of: forming the cut-off portion by cutting off a portion of the side wall portion after forming the cylindrical side wall portion.

(2) In the invention, the side wall portion may be formed by drawing.

(3) In the invention, when the side wall portion is formed, a bottom portion which is formed at one end side of the side wall portion may be cut and bent in an axial direction of the motor by drawing so as to form pole teeth.

(4) In the invention, the cut-off portion may be formed by cutting the side wall portion in a direction parallel to an axial direction of the motor.

### BRIEF DESCRIPTION OF THE DRAWINGS

FIG. 1 is a front elevational view, partly in section, of a geared motor using a motor casing A in accordance with the invention;

FIG. 2 is a perspective view illustrating an embodiment of the motor casing in one process in the method of manufacturing a motor casing in accordance with the invention;

FIG. 3 is a perspective view of the motor casing illustrating the cutting direction for forming cut-off portions;

FIG. 4 is a perspective view of the motor casing in which the cut-off portions have been formed; and

FIG. 5 is a perspective view illustrating another embodiment of the motor casing in one process in the method of manufacturing a motor casing in accordance with the invention.

### DETAILED DESCRIPTION OF THE PREFERRED EMBODIMENTS

Referring now to the drawings, a description will be given of an embodiment of a method of manufacturing a motor casing in accordance with the invention.

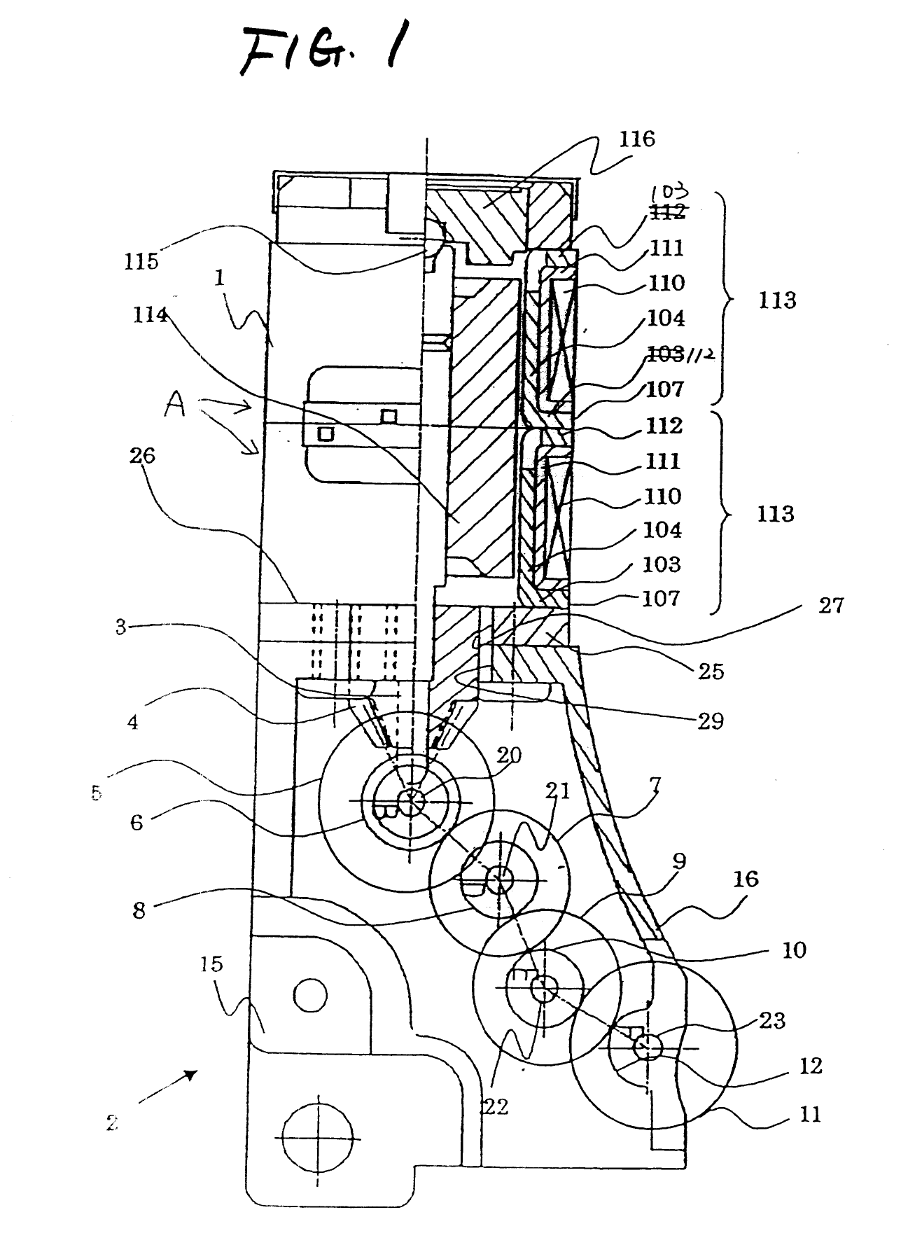

FIG. 1 is a front elevational view, partly in section, of a geared motor using a motor casing A in accordance with the invention.

In FIG. 1, a gear box 2 is fixed to one end of a motor 1. A plurality of transmission gears for transmitting the driving force from the motor 1 to a rotating shaft are incorporated in the gear box 2, as will be described later, and a geared motor is thereby formed.

The gear box 2 has a housing constructed by fitting together a pair of housing halves 15 and 16. This housing surrounds a rotating shaft 3 of the motor 1 and the transmission gears. Pivotally supporting portions for pivotally supporting respective both ends of transmission gear shafts 20, 21, 22, and 23 are formed on opposing surfaces of the housing which are formed parallel to each other.

An insertion port 27 for inserting the rotating shaft 3 of the motor 1 in such a manner as to penetrate a coupling surface 26 is formed in a coupling plate 25, and an insertion port 29 for the rotating shaft 3 is also formed in a portion of the housing half 15 corresponding to its end plate. It should be noted, however, a bevel gear 4 is fitted over the rotating shaft 3 and is rotatable integrally with the rotating shaft 3, and a cylindrical trunk portion of the bevel gear 4 is inserted in the aforementioned insertion ports 27 and 29.

A rotating member in which a second bevel gear 5 with a diameter larger than that of the bevel gear 4, as well as a small-diameter spur gear 6, are integrally formed is fitted on the transmission gear shaft 20, and the bevel gear 4 and the second bevel gear 5 mesh with each other. A rotating member in which a large-diameter spur gear 7 and a small-diameter spur gear 8 are integrally formed is fitted on another transmission gear shaft 21, and the gear 6 and the gear 7 mesh with each other. A rotating member in which a large-diameter spur gear 9 and a small-diameter spur gear 10 are integrally formed is fitted on still another transmission gear shaft 22, and the gear 8 and the gear 9 mesh with each other. A rotating member in which a large-diameter spur gear 11 and a small-diameter spur gear 12 are integrally formed is fitted on a further transmission gear shaft 23, and the gear 10 and the gear 11 mesh with each other.

The aforementioned motor 1 is a stepping motor having an annular rotor magnet 114, which is rotatively driven together with the rotating shaft 3, and a stator 113. In the illustrated embodiment, two stators 113 are superposed in the thrust direction of the rotating shaft 3.

In addition, a steel ball 115 and a thrust bearing 116 are disposed in the motor 1 so as to position the rotating shaft 3 in the thrust direction.

The stator 113 has the motor casing A in accordance with the invention, coils 110, and a yoke plate 112. Here, the motor casing A includes a side wall portion 101 having a pair of cut-off portions 107, and a plurality of pole teeth 104 arranged in a comb shape in such a way as to oppose a peripheral surface of the rotor magnet 114, and a hole 105 for inserting the rotor magnet 114 is formed in the motor casing A. The coil 110 wound around a bobbin 111 is fitted on an outer periphery of each pole teeth 104 of the motor casing A, and an inner yoke plate 112 is attached thereto. Here, the inner yoke plate 112 has a plurality of pole teeth 104 arranged at the same intervals as those of the pole teeth 104 of the motor casing A, as well as a hole for the insertion of the rotor magnet 114. When the inner yoke plate 112 is fitted to the motor casing A, the inner yoke plate 112 is disposed such that the pole teeth of the yoke plate 112 are mutually adjacent to the pole teeth 104 of the motor casing A.

Hereafter, a description will be given of the method of manufacturing the motor casing A in accordance with the invention. FIGS. 2 to 4 are diagrams illustrating an embodiment of the method of manufacturing the motor casing A in accordance with the invention.

First, as shown in FIG. 2, the side wall portion 101 and the pole teeth 104 are formed. The side wall portion 101 is formed into a cylindrical shape by subjecting a flat plate-shaped member to drawing a number of times. In the process of this operation, notches are formed in a bottom portion 103, and the formed cutouts are bent in the axial direction of the motor casing A, which is to be an axial direction of the assembled motor, thereby to form the pole teeth 104. These pole teeth 104 and the side wall portion 101 are subjected to further drawing to have predetermined lengths for the pole teeth 104 and the side wall portion 101.

Since the bottom portion 103 is cut out and bent, the hole 105 is formed in the bottom portion 103 after forming the pole teeth 104.

Here, in the illustrated embodiment, the three pole teeth 104 thus formed have the same shapes, and are formed at equal intervals of 120° with respect to the central point of the bottom portion 103.

Since the pole teeth 104 are formed by drawing, the height of the pole teeth 104 is not restricted by the radius of the bottom portion 103. Namely, the height of the pole teeth 104 can be made longer than the radius of the bottom portion 103, with the result that it is possible to obtain high motor torque.

Next, the cut-off portions 107 are formed in the cylindrical side wall portion 101.

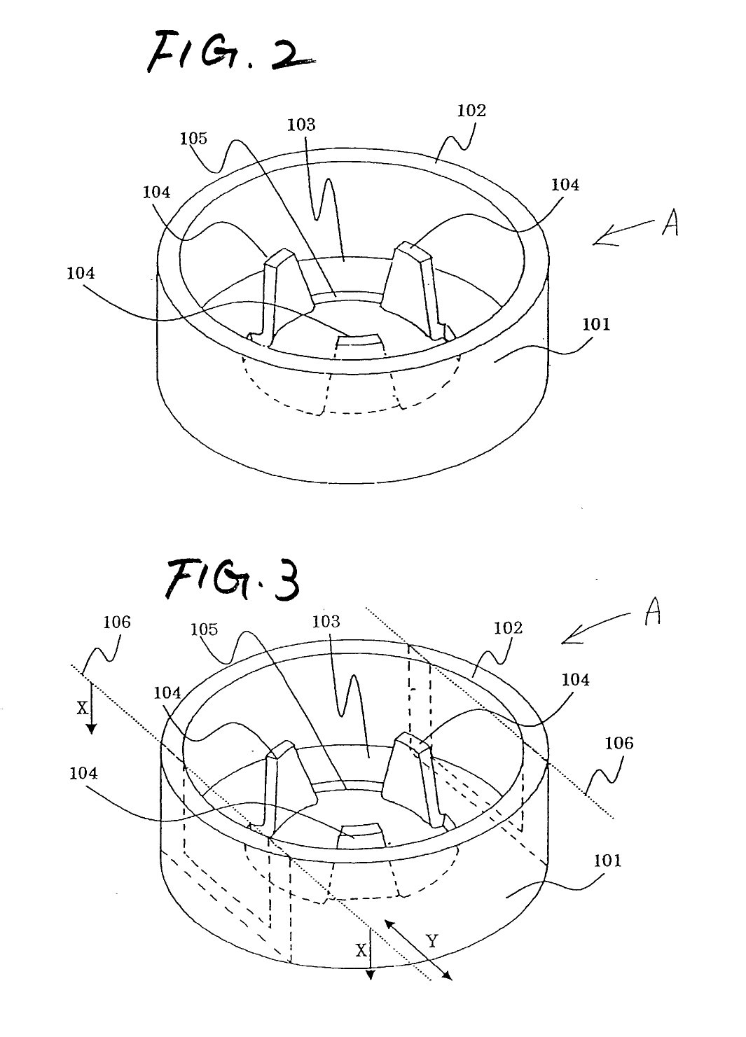

The cut-off portions 107 are formed by cutting off portions of the cylindrical side wall portion 101 parallel to the axial direction. FIG. 3 shows two phantom lines 106 which are perpendicular to the axial direction and are parallel to each other at the time when the cut-off portions 107 are formed in two portions of the side wall portions 101.

The direction in which the side wall portion 101 is cut when the cut-off portions 107 are formed is parallel to the axial direction (the direction of X in the drawing) . In this embodiment, a method is adopted in which the side wall portion 101 is cut along the axial direction from an opening 102 side, but it goes without saying that a method in which the side wall portion 101 is cut from the bottom portion 103 side may be adopted In the case where the side wall portion 101 cut along the axial direction, as compared with the case where it is cut in the radial direction perpendicular to the axial direction (in the direction of Y in the drawing), it becomes possible to effect machining in a state in which the rigidity of the motor casing A is kept high. As this method of cutting the side wall portion in a direction parallel to the axial direction is used in combination with the method of forming the cut-off portions by cutting off portions of the side wall portion after the formation of the side wall portion, it becomes possible to effect machining in the state in which the rigidity of the motor casing A is kept higher. Consequently, it is possible to further ensure the dimensional accuracy of the motor casing A.

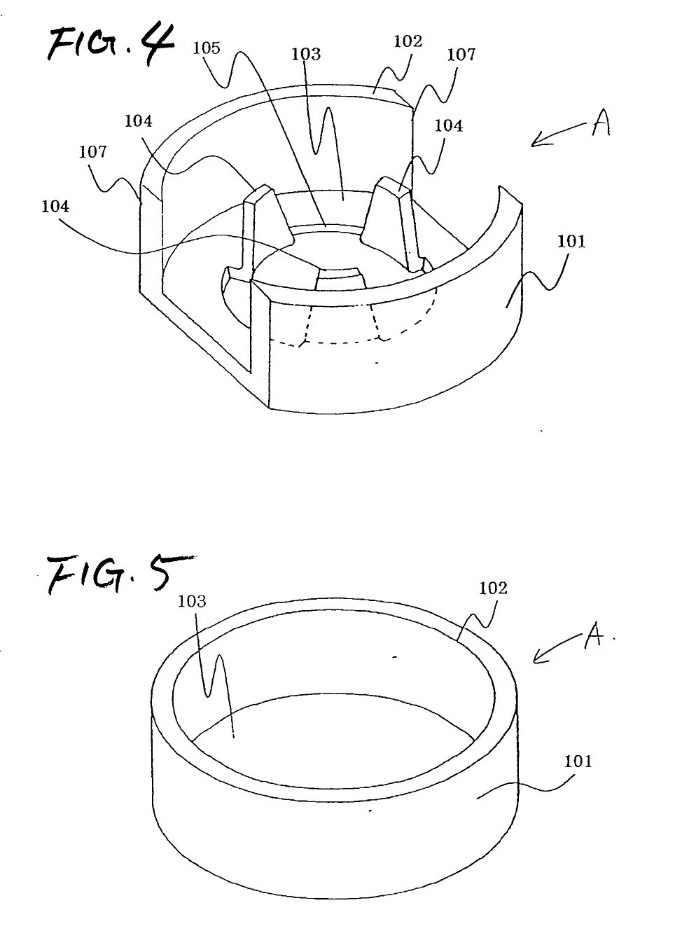

As shown in FIG. 4, the motor casing A with the cut-off portions 107 formed therein is a partially cylindrical shape which is substantially oval in terms of its outer shape in a plan view. Accordingly, by forming the cut-off portions 107, it is possible to make the motor casing A compact in the widthwise direction.

In the above-described embodiment, as for the motor casing A, the cut-off portions 107 are formed after forming the side wall portion 101 and the pole teeth 104 by drawing. According to this manufacturing method, as compared with the case where the side wall portion and the pole teeth are formed by drawing after the formation. of the cut-off portions in advance, it is possible to effect machining with the rigidity of the motor casing A kept high, with the result that it is possible to ensure the dimensional accuracy. Further, as the method of forming the cut-off portions 107 after forming the side wall portion 101 and the pole teeth 104 is used in combination with the method of cutting parallel to the axial direction at the time of forming the cut-off portions 17, it becomes possible to effect machining in the state in which the rigidity of the motor casing A is kept higher.

According to the above-described embodiment, by forming the cut-off portions 107 in some portions of the aforementioned side wall portion 101 after forming the cylindrical side wall portion 101, it becomes possible to effect machining without changing the diameter of the rotating shaft and the number of windings of coils and in the state in which the rigidity of the motor casing A is kept high. Consequently, it becomes possible to secure the dimensional accuracy and make the motor casing A compact.

Although in the above-described embodiment the number of pole teeth is set to three, the number of the pole teeth is not limited to the same.

In addition, although in the above-described embodiment a description has been given of the example of the motor casing A having pole teeth, the method of manufacturing such a motor casing A in accordance with the invention is also applicable to the motor casing A which does not have the pole teeth but has only the cut-off portions 107. Namely, after the cylindrical side wall portion 101 shown in FIG. 5 is formed by drawing, if portions of the side wall portion 101 are cut off as described in the foregoing embodiment to form the cut-off portions 107, it is possible to manufacture the motor casing A.

In accordance with the invention, in the method of manufacturing a motor casing with a cut-off portion, the cut-off portion is formed by cutting off a portion of the side wall portion after forming the cylindrical side wall portion. Therefore, it becomes possible to effect machining without changing the diameter of the rotating shaft and the number of windings of coils and in the state in which the rigidity of the motor casing is kept high. Consequently, it becomes possible to secure the dimensional accuracy and make the motor casing compact.

In accordance with the invention, even in a case which involves machining that lowers the rigidity of the motor casing as in the case of drawing for forming the side wall portion by drawing it thinly, it becomes possible to effect machining in the state in which the rigidity of the motor casing is kept high. Hence, this method is more effective.

In accordance with the invention, when the side wall portion is formed, a bottom portion which is formed at one end side of the side wall portion is cut out and bent in an axial direction by drawing so as to form pole teeth. Therefore, even in a case which involves machining that further lowers the rigidity of the motor casing, it becomes possible to effect machining in the state in which the rigidity of the motor casing is kept high. In addition, since the pole teeth can be made long without being restricted by the radius of the bottom portion of the motor casing, it is possible to obtain high motor torque.

In accordance with the invention, the cut-off portion is formed by cutting the side wall portion in a direction parallel to an axial direction. Therefore, as this method of cutting the side wall portion in a direction parallel to the axial direction is used in combination with the method of forming the cut-off portions by cutting off portions of the side wall portion after the formation of the side wall portion, it becomes possible to effect machining in the state in which the rigidity of the motor casing is kept higher.

What is claimed is:

1. A method of manufacturing a motor casing with a cut-off portion in a cylindrical side wall portion, comprising the step of:
forming said cut-off portion by cutting off a portion of said side wall portion after forming said cylindrical side wall portion.

2. The method of manufacturing the motor casing according to claim 1, wherein said side wall portion is formed by drawing.

3. The method of manufacturing the motor casing according to claim 2, wherein when said side wall portion is formed, a bottom portion which is formed at one end side of said side wall portion is cut and bent in an axial direction of the motor by drawing so as to form pole teeth.

4. The method of manufacturing the motor casing according to claim 1, wherein said cut-off portion is formed by cutting said side wall portion in a direction parallel to an axial direction of the motor.
